(19) United States
(12) Patent Application Publication
(10) Pub. No.: US 2024/0095475 A1
(43) Pub. Date: Mar. 21, 2024

(54) SECURITY MONITORING SYSTEMS

(71) Applicant: Utterberry Ltd, London (GB)

(72) Inventor: Heba BEVAN, Bromley (GB)

(21) Appl. No.: 18/255,559

(22) PCT Filed: Dec. 2, 2021
(86) PCT No.: PCT/EP2021/084069

§ 371 Date: Jun. 1, 2023

(30) Foreign Application Priority Data
Dec. 2, 2020 (GB) 2018999.9

(51) Int. Cl. G06K 7/10

(52) U.S. Cl. CPC G06K 7/10366

(57) ABSTRACT

A carrier to carry user belongings for a security screening system e.g. of an airport. The carrier comprises a token reader to wirelessly read a user token to determine a user token identifier, and a carrier identifier to distinguish the carrier from amongst the multiple carriers of the security screening system. The carrier identifier is stored in the carrier. A carrier controller is configured to read the user token of a user issued with the carrier to carry their belongings, to determine the user token identifier of the user, store the user token identifier read from the user token, read the stored carrier identifier, and transmit the stored user token identifier in association with the stored carrier identifier.

### FIELD

This specification relates to security monitoring systems for baggage scanners and the like.

### BACKGROUND

Airports and other locations employ baggage scanners such as X-ray scanners to screen user belongings. Typically hand luggage, handbags, electronic equipment, some clothing and smaller personal items, liquids, and similar items, generically referred to herein as user belongings, are placed in a tray. The tray is carried through a baggage scanner or similar security screening system on a conveyor system, and the belongings are collected on the far side of the baggage scanner. In this specification a person using the scanner in this way is referred to as a user; a person involved monitoring or administration of the scanning process is referred to as a security officer.

There is a general need to improve the efficiency of such systems, particularly as the throughput of users increases. More specifically there is need to reduce the risk of abandoned baggage, and to provide more comfort to users that their belongings will not go astray.

Background prior art can be found in CN111340153A, which describes a security check tray electronic issuing machine based on RFID.

### SUMMARY

This specification generally relates to monitoring security screening systems with a view to improving security.

In one aspect there is described a carrier, such as a tray or mat, to carry user belongings for a security screening system, where the security screening system is configured to screen multiple such carriers.

The carrier may comprise a token reader to wirelessly read a user token to determine a user token identifier. The user token may be, for example, a smart phone or printed NFC (Near Field Coupling) tag, or in some implementations machine-readable user identity document such as a passport.

The user token identifier may be anonymous i.e. it may not directly identify the user (but may be linked to a user identifier). Or the user token identifier may directly identify the user e.g. it may include the user's name.

The carrier may also comprise a carrier identifier, e.g. a number or alphanumeric string, to distinguish the particular carrier from amongst the other carriers of the security screening system. The carrier identifier may be stored in the carrier, e.g. in local memory.

The carrier may include a carrier controller e.g. a local microprocessor or microcontroller, configured to read a user token to determine the user token identifier of a user, specifically of the user issued with the carrier to carry their belongings, store the user token identifier read from the user token, read the stored carrier identifier e.g. retrieve the stored carrier identifier from memory, and transmit the stored user token identifier in association with the stored carrier identifier e.g. to a base station and/or the cloud where it may be stored, processed, or accessed for interrogation.

In implementations an association is maintained between a user and the carrier holding their belongings. This reduces the burden on security officers and makes it easier to spot when a carrier has been abandoned. It can also provide evidence of a link between a user and their belongings, e.g. in the case of criminal activity. In some implementations the carrier may provide user feedback regarding the status of the screening and monitoring process, providing reassurance. Data collected from the system may facilitate more general improvements to security management.

In some implementations the carrier controller is configured to detect one or more carrier events, such as a carrier use start event and a carrier use stop even. The carrier controller may then transmit an event signal comprising the stored user token identifier in association with the stored carrier identifier in response to the detected one or more carrier events. The event signal may identify the detected carrier event i.e. it may identify the existence of a carrier event or a type of the detected carrier event.

One difficulty that can arise is in such a system is that carriers such as trays may be moved between screening systems (“machines”). Another is the potential need for a reliable evidential trail of system use. Blockchain is helpful in this regard as it is resistant to data modification, but there can be difficulties with providing fine-grained access control for stored data. Depending upon the application there may also be a need to control user's personal data e.g. for regulatory reasons.

In some implementations these difficulties are addressed by a hierarchical blockchain approach. Thus a carrier, e.g. tray, blockchain may be used to build a chain of carrier events for each carrier, blocks of which may in turn be used to construct further blockchains. The data transmitted from the carrier may be protected by a secret key. Thus a second, security check blockchain may be built using blocks from the carrier blockchains, e.g. from the carrier blockchains of the carriers (trays) associated with a particular machine. A local base station may track which carriers are associated with each machine; each base station may have access to the blockchains of all the carriers.

In some implementations the user token identifier is anonymous and the system generates a user token identifier for a user and links the anonymous user token identifier with a (direct) user identifier e.g. a user's name. Then a further blockchain may connect the anonymous user token identifier and the user identifier e.g. to build a blockchain which tracks all the carriers and/or carrier events associated with a particular user. In some other implementations, e.g. where the user token identifier identifies the user, the second, security check blockchain may perform this function.

In some implementations there may be a further permissions blockchain which may comprise data for defining rules to control access to the data (blocks) of the other blockchains.

In another aspect there is described a server for the security screening system. The server may be configured to receive the event signal is encrypted with the carrier key, decrypt the event signal encrypted with the carrier key, and add a block to the carrier blockchain for a carrier identified by the stored carrier identifier in the event signal. The block may comprise at least data identifying the carrier event, a time of the carrier event, and the user token identifier in the event signal.

In another aspect there is described a method performed by one or more computers, for monitoring screening of user belongings. The method may comprise receiving, from a carrier of user belongings an event signal identifying a carrier event, that is either identifying the existence of the carrier event i.e. a notification that an event has taken place, or identifying a type of the carrier event. The event signal may also include a user token identifier associated with the user, and a carrier identifier identifying the carrier.

The method may include maintaining a first blockchain, e.g. a carrier or security check blockchain as previously described, including blocks each linking the carrier event, the user token identifier, and the carrier identifier.

As previously described the user token identifier may be anonymous or e.g. where derived from a passport, it may include a (direct) user identifier such as a name. Where the user token identifier is anonymous the method may include issuing the user with the user token identifier, linked to a (direct) user identifier, e.g. to a user's name, and maintaining a second, user blockchain including blocks linking at least the user identifier, the user token identifier, and the carrier identifier. This may involve creating a blockchain which links the (direct) user identifier with a carrier identifier, and optionally carrier events, e.g. by including this information in blocks of the blockchain.

In some implementations of the above described systems and methods the carrier events/event signals may include carrier weight data derived from a sensed carrier weight.

In implementations of the above described systems and methods the data captured and generated by the system, in particular the data in blocks of one or more of the described blockchains, may be accessed by a security officer e.g. displayed on a terminal local to a security screening system, or provided for remote access.

There is also provided computer program code, e.g. stored on one or more computer readable media, and configured to control one or more computers to implement the systems and methods described above. The code (computer program) may be provided on a non-transitory data carrier e.g. on one or more physical data carriers such as a disk or programmed memory such as non-volatile memory (eg Flash) or read-only memory (Firmware). Code and/or data to implement examples of the system/method may comprise source, object or executable code in a conventional programming language, interpreted or compiled), such as C, or assembly code, or code for a hardware description language. The code and/or data to implement the systems may be distributed between a plurality of coupled components in communication with one another.

### DRAWINGS

These and other aspects of the invention will now be further described by way of example only, with reference to the accompanying Figures, in which:

FIG. 1 shows an example security screening system.

FIG. 2 shows an example process for the security screening system of FIG. 1.

FIGS. 3a and 3b show, respectively, a baggage scanning machine with elements of the security screening system of FIG. 1, and details of example carriers.

FIG. 4 shows an example state transition diagram for a carrier.

FIG. 5 shows, schematically, an example blockchain data model for the security screening system of FIG. 1.

Like elements are indicated by like reference numerals.

### DESCRIPTION

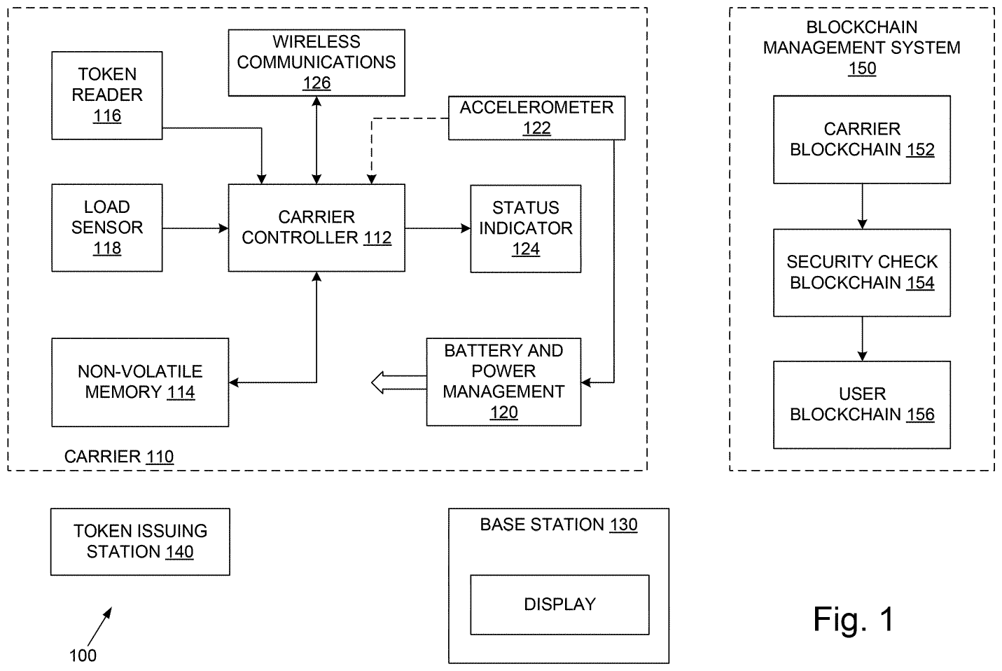

Referring to FIG. 1, this shows an example security screening system 100. The system comprises multiple carriers, of which one carrier 110 is shown. Each carrier 110 may be a tray or mat in or on which user belongings may be placed.

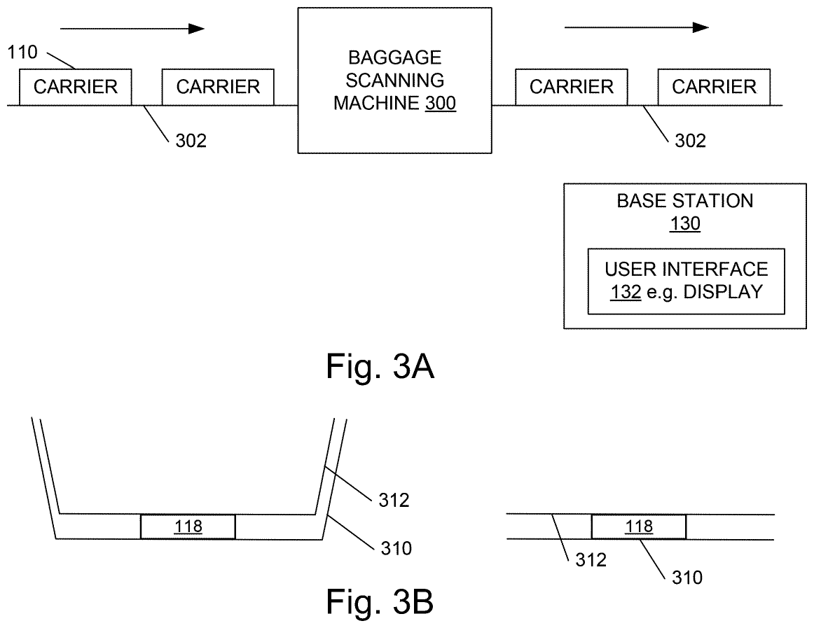

As shown in FIG. 3a (not shown in FIG. 1), the security screening system 100 typically also includes a baggage scanning machine 300 and a conveyor system 302 for conveying the carriers through the baggage scanning machine. The baggage scanning machine 300 may have an associated base station 130, and may also have an associated set of carriers.

The security screening system 100 may have multiple baggage scanning machines 300 and multiple base stations 130.

Continuing to refer to FIG. 1, the carrier 110 includes a carrier controller 112, such as a microcontroller, and non-volatile memory 114 such as Flash memory (shown separately but which may be part of the micro controller). Memory 114 stores program code for controlling operation of the carrier controller, and also data. The carrier may also include working memory (not shown).

In particular memory 114 stores a carrier identifier, which may be a number or alphanumeric string, to distinguish the carrier from amongst the multiple carriers of the security screening system. The carrier identifier may uniquely identify the carrier from amongst a set of carriers of a particular security screening system (baggage scanning machine); or from amongst a larger group of carriers associated with multiple baggage scanning machines, e.g. at an airport, to facilitate carriers being moved between machines. Each carrier may be registered with a particular security screening system (baggage scanning machine).

In implementations each carrier 110 has a secret key e.g. a private key of a public-key cryptographic system. The carriers may share a secret key or each may have a different respective secret key. Memory 114 may store the carrier secret key.

The carrier 110 also includes a token reader 116 to wirelessly read a user token. The user token is wireless-readable e.g. NFC-readable; the token reader 116 may be an NFC reader. For example the user token may be a ticket with an NFC tag, or sticker with an NFC tag which may be attached to a ticket; or the user token may be a smart phone with NFC communication capability. The user token, e.g. the NFC tag or smart phone, has or is programmed with a user token identifier, which is read by token reader 116.

The user token identifier may be issued by a token interface such as a token issuing station 140. For example this may involve physically issuing a user token bearing the user token identifier e.g. by printing an NFC tag sticker (available off the shelf) which, in a transport hub setting, may then be attached to a user's ticket e.g. onto a boarding pass. Or this may involve electronically issuing the user token identifier e.g. by wirelessly providing a smart phone with the user token identifier. Where an NFC tag sticker is printed a user name, and optionally other user details such as a ticket or flight number, may be printed on the NFC tag sticker.

The user token identifier may be a number or alphanumeric string which is allocated to the user as described later, in which case the user token identifier may not reveal an identity of the user without additional information such as a mapping code to map from the user token identifier to an actual user identifier. Such a user token identifier may be referred to as anonymous.

When the user token identifier is anonymous the system may be configured to obtain a user identifier such as a user's name and/or address. In implementations the system may also obtain travel details such as a flight number, e.g. from another system such as a booking or travel management system. The system may keep a record of a link between the user identifier and the user token identifier issued to the user identified by the user identifier, e.g. using a blockchain as described later. When the user token identifier is anonymous this information may be used later to associate a particular carrier with a particular, identified user.

Also or instead a user token may be a machine-readable passport or similar user identity document, e.g. where the system is deployed at a transport hub such as an airport. Then the user token identifier may be read from the passport/user identity document. In this case the user token identifier may reveal the identity of the user e.g. without a mapping code. In this case the token reader 116 may be any suitable reader for e.g. wireless machine-reading the passport/user identity document.

In implementations the carrier 110 includes a load sensor 118 to sense when a load from user belongings is present on the carrier i.e. in a tray or on a mat. Thus the load sensor may be part of a weight detection system to sense a weight on the carrier, either to measure the weight or to merely to sense presence of a weight greater than a threshold value.

For example, referring to FIG. 3b, in some implementations the carrier has a lower part e.g. supported by a conveyor 302 of the security screening system 300, and an upper part to support the user belongings. For example where the carrier is a tray (FIG. 3b, left) the lower part may comprise an outer shell 310 of the tray and the upper part an inner shell 312 of the tray. The load sensor 118, e.g. a force sensitive resistor, may then be located between the lower part and the upper part of the carrier. In other implementations (FIG. 3b, right) the load sensor may be located between layers of a carrier such as a mat. The carrier controller processes signals from the load sensor 118 to determine (sense or measure) a weight in the carrier.

The carrier 110 may include a battery and power management system 120 to provide power for the electronics of the carrier. This system may include an accelerometer 122 or other movement sensor to sense motion of the carrier and wake the controller from a low power sleep mode. The accelerometer, where present, may also or instead provide an input to the carrier controller 112 to sense or assist in sensing carrier events (described later).

The carrier 110 may receive power wirelessly e.g. via a magnetic induction coil, or via wired connections such as spring-loaded contacts on a periphery of e.g. at corners of the carrier to avoid obstructing the carrier scanning machine. In implementations the contacts are arranged so that when the carriers are stacked the electrodes of adjacent carriers connect to form an electrically continuous connection through the stack. For example an electrode may extend through the carrier and be exposed on respective surfaces of the lower part and the upper part of the carrier.

The electrodes may be arranged so that rectangular carriers can be stacked either way around i.e. so that they have 2-fold (180 degree) rotational symmetry. Thus the electrodes may comprise electrodes of two polarities arranged e.g. at diagonally opposite corners, such that when the carrier is stacked electrodes of corresponding polarity of the adjacent carriers connect to form an electrically continuous connection through the stack for each of two rotational orientations of the carrier. Within a carrier electrodes of the same polarity may be connected to provide redundancy in case of a bad contact.

The carrier 110 may include a status indicator 124 which may be a visual indicator e.g. a multi-colored indicator such as an LED, or an LCD screen. The status indicator 124 is controlled by the carrier controller 112 to provide e.g. a ready/correct operation/error e.g. blue/green/red indication of a status of the carrier. For example the status indicator may indicate an error if a signal from the weight detection system indicates that there are user belongings in the carrier (weight detected), but a user token has not yet been read.

The carrier 110 may also include a wireless communications link 126 for communicating with other elements of the security screening system 100 such as one or more base stations 130 of the system. The wireless communications link 126 may e.g. comprise a Bluetooth™ link such as a BLE (Bluetooth™ Low-Energy) link. In implementations data transmissions from the carrier, e.g. to base station, are encrypted using the secret key of the carrier. A star topology may be used for communications between a base station and its associated carriers. The base station may have a user interface, e.g. a display, for interrogating data captured by the system.

Referring again to FIG. 3b, the carrier electronics i.e. the carrier controller 112 and other elements described above (apart from the load sensor), may be located, e.g. on a substrate, between side walls of the inner shell and the outer shell. In this way the electronics is kept generally clear of the user belongings for scanning. The carrier itself may be made of a material which is substantially x-ray transparent e.g. a polymer.

In use the carrier controller 112 reads the user token of a user issued with the carrier to carry their belongings, using token reader 116, to determine the user token identifier of the user. The carrier controller 112 then stores the user token identifier read from the user token in working memory and/or non-volatile memory 114. The carrier controller 112 also reads the stored carrier identifier e.g. from non-volatile memory 114, and then transmits the stored user token identifier in association with the stored carrier identifier e.g. to base station 130 and/or to some other component of the system.

In more detail, the carrier controller is configured to detect one or more carrier events, such as a carrier use start event and a carrier use stop event. These may be detected using load sensor 118 to sense a load or a change in load on the carrier indicating that a user has placed one or more objects on, or removed one or more objects from the carrier. The carrier controller may then transmit an event signal comprising the stored user token identifier in association with the stored carrier identifier, in response to the detected carrier event. The event signal may also identify the (type of) detected carrier event e.g. carrier use start/stop, and may optionally include additional data such as a time stamp or the sensed weight. In implementations the event signal is encrypted using the secret key of the carrier.

The security screening system 100 also includes a blockchain management system 150, configured to manage one or more blockchains. Use of blockchains to manage data within the system helps to make the system resilient to network failures, e.g. by means of distributed storages of the blockchain data, and to data errors, both of which are important in a security context. The described system also facilitates the implementation of complex data access permissions.

In FIG. 1 the blockchain management system 150 is for convenience drawn as a single entity but in general comprises multiple members. The physical embodiment of a member may be as one or more of the base stations 130, or as one or more local servers, that is one or more servers physically in the vicinity of the security screening system 100, or as one or more remote servers i.e. in the cloud. In general the members of the blockchain management system 150 are in communication with one another to a sufficient degree to maintain the blockchains described below. Some members of the blockchain management system 150 may communicate directly with some or all of the carriers 110.

In some implementations the blockchain management system 150 has network management service software which may be used to establish members of the blockchain management system 150 and their permissions, to distribute keys and certificates to access blockchain data, and so forth. The network management service software may be accessed by a local or remote server or by one or more of the base stations.

In some implementations the blockchain management system 150 manages blockchains using a blockchain consensus mechanism. This may require that an addition to a blockchain is approved by the consensus mechanism. In implementations the blockchains are private blockchains i.e. there is an authorization protocol which is required for a member to join the blockchain management system. In this case the consensus mechanism may be a simple majority vote. In general, although not explicitly described later, each block of a blockchain will include a hash of the previous block in the blockchain in the usual way.

As shown in FIG. 1 the blockchain management system 150 manages a carrier blockchain 152, a security check blockchain 154 and a user blockchain 156, as described further below. However in some implementations fewer blockchains may be used and the data in some of these blockchains may be combined.

In some implementations one or more individual fields of each block of one or more of the blockchains are encrypted using a secret key. This allows access to these individual fields to be controlled by a suitable key distribution system, whilst still allowing members of a blockchain to validate new blocks added to the blockchain: Any member (of the blockchain) can validate a new block but only members with a suitable e.g. per field key can access data in a particular field. Key distribution may be managed by a central service on a local or remote server, e.g. by the network management service, and/or controlled by a permissions blockchain.

In implementations an element of the security screening system 100, e.g. a base station 130, receives an event signal from a carrier encrypted with the carrier key, and decrypts the event signal e.g. using a corresponding public key. The base station 130 uses the blockchain management system 150 maintain a carrier blockchain 152 for each carrier associated with e.g. registered to the base station 130. Thus in implementations the carrier key is needed to add a carrier block to the carrier blockchain for the carrier.

Thus a carrier block is added to the carrier blockchain, the carrier block including data identifying the carrier event (data identifying that the even happened or data identifying the type of event), a time of the carrier event, and the user token identifier read from the token of the user of that particular carrier (read when the user acquired the carrier). The carrier block may also include the sensed weight of the user belongings.

The base station 130 uses a local data service (software) running on the base station 130 to add the carrier block to the carrier blockchain. The base station 130, i.e. the local data service also forwards the carrier block to members of the blockchain management system 150, e.g. to each member of the blockchain management system 150 with permission to access the carrier block, these members form the carrier blockchain consensus.

Generally, each member only stores carrier blockchains and validates blocks for which it has permission; the base station forwarding the carrier block is normally one such member. This base station 130 may also maintain a local backup of the carrier blockchain, to improve resilience of the system. Typically a base station 130 is associated with a baggage scanning machine and only that base station communicates with the carriers of that machine. Where a carrier is moved from one baggage scanning machine to another, the base station of the new machine may join the carrier blockchain consensus; optionally the original base station may leave. This may be managed by the network management service.

The base station 130 e.g. the local data service, may provide a local interface for a security officer e.g. to display data from event signals (packets). These event signals or “packets” may comprise e.g. carrier user start and carrier use stop packets, which may be displayed with an animation of the security scanning system and associated data such as the user token identifier and carrier weight. Optionally an electronic device such as a smart phone may also be equipped with software to interrogate a carrier directly to obtain similar information. Access to this information may be controlled as previously described.

The carrier blockchain acts as a data integrity check but may be omitted where there is a reduced requirement for such data integrity.

The security screening system 100, in particular the blockchain management system 150, may also maintain a security check blockchain 154. Security check blocks of the security check blockchain may each comprise a carrier identifier, data identifying a carrier event, e.g. a type of carrier event, for the identified carrier, and a time of the carrier event. Optionally other information, such as a carrier weight, may also be included. A security check blockchain may be maintained for each user. At least a root block of the security check blockchain may include the user token identifier. Thus in broad terms the security check blockchain records data relating to a security check for a particular user, e.g. passenger, which may include data from multiple different carriers. However the user may (but need not be) be anonymous. In implementations the user token identifier allows the particular user to be identified from data linking the user token identifier with user identity data such as a name and/or address. It will be appreciated that there may be many security check blockchains.

In implementations, one or more members of the blockchain management system 150 may run upstream aggregation service software to manage the security check blockchains. The upstream aggregation service may receive carrier events, which may be encrypted (or otherwise signed), and members with permission may decrypt these carrier events. The upstream aggregation service is responsible for updating the carrier blockchains (where implemented), and also the security check blockchains. That is, when a carrier blockchain is updated the upstream aggregation service may also update the corresponding security check blockchain i.e. the security check blockchain the same user token identifier. The consensus mechanism ensures consistency between the distributed copies of the blockchains in the usual way.

As previously, only members with permission to access/add blocks of the security check blockchain form part of the security check blockchain consensus. Each member of the security check blockchain consensus may maintain a local copy of the security check blockchains.

In implementations additional or alternative blockchains may be constructed. For example there may be a security check blockchain constructed for each individual baggage scanning machine, to create a security check block for each carrier event of each carrier associated with that particular machine.

The security screening system 100, in particular the blockchain management system 150, may also maintain a user (e.g. passenger) blockchain 156. This may comprise user blocks including personal user data such as a user name or address or travel details. More particularly where the user token identifier is anonymous at least one user block of the user blockchain, e.g. a root block, may comprise at least the user token identifier and the user identifier, thereby linking these. In general user blocks of the user blockchain each link to carrier event e.g. via a security check block of a security check blockchain to a carrier block of a carrier blockchain. Thus the user (e.g. passenger) blockchain 156 may provide information relating to a particular, identified user such as one or more of: which carrier or carriers they used (carrier identifier), and when (event signal; time stamp), and the weight in each carrier.

A blockchain member, e.g. the upstream aggregation service software, may provide an interface for accessing this data, retrieved from a blockchain, again according to defined permissions. More particularly a monitoring and analysis application may use the upstream aggregation service to obtain this data. This data may include at least data from one or both of the stored user token identifier (linked to the user identifier) and the stored carrier identifier, but may include additional data as described above. In some implementations such data may be made available via an operator interface e.g. displayed, on a base station 130. Where the data includes personal data this may be temporarily locally cached in the base station 130 and afterwards deleted.

Optionally data may be aggregated from multiple blockchains and used to provide information relating to operation the security screening system 100 as a whole, such as user numbers over a period, or user throughput. Optionally this information may be processed e.g. using an AI (artificial intelligence)-based to adjust operating parameters of the system to improve system performance.

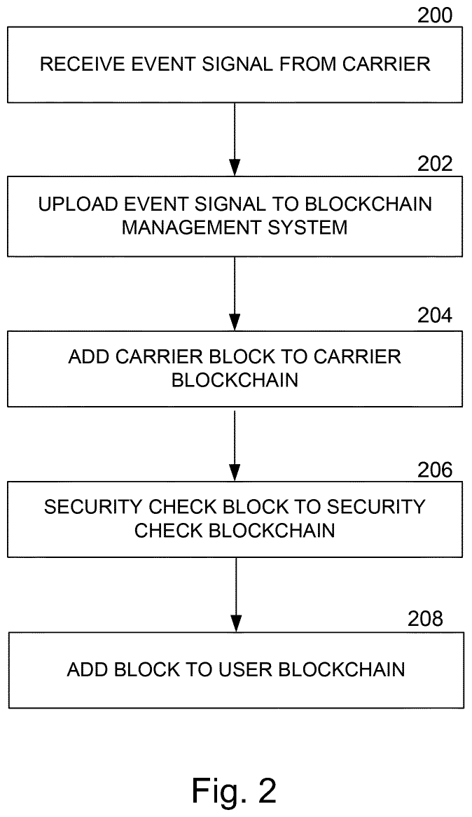

FIG. 2 shows a process for operating the security screening system 100 of FIG. 1. An event signal is received from a carrier e.g. at a base station 130 (step 200), and uploaded to the blockchain management system 150 (step 202). The event signal includes a user token identifier, e.g. from an NFC user token or identity document associated with the user, and a carrier identifier identifying the carrier. When encrypted the event signal may be decrypted by a member of the blockchain management system, and/or locally at the base station.

A corresponding carrier block is added to the carrier blockchain to update the carrier blockchain (step 204). The (signed) carrier block, or alternatively information derived directly from the carrier event, is used to add a security check block to the security check blockchain (step 206). Thus a security check block may be created linking the carrier event to the user token identifier and the carrier identifier. In some implementations e.g. where the user token identifier is anonymous, the security check block, or alternatively information derived directly from the carrier event or from the carrier block, is used to add a user block to the user blockchain (step 208). Thus a user block may be created linking the user identifier, the user token identifier, and the carrier identifier.

Thus implementations of the security screening system create authenticated, distributed, and permission-controlled protected data which can be queried, with suitable permission, to link an identified e.g. named user of the system with one or more carriers that they have used, and when, and optionally to determine a weight of their belongings, optionally at multiple different times.

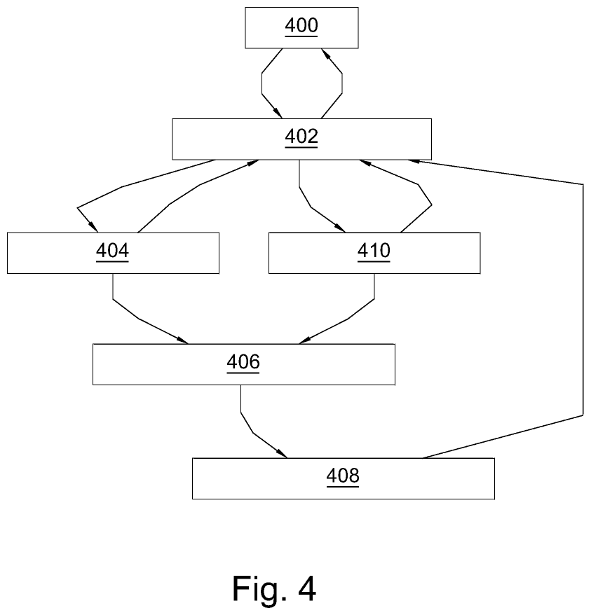

FIG. 4 shows an example state transition diagram for a carrier. The carrier transitions to a sleep mode 400 following a “timeout” period of inactivity, and is woken on detection of motion e.g. by accelerometer 122. The carrier then transitions to a ready state 402, activates token reader 116 and load sensor 118, and sets the status indicator 124 to ready (e.g. blue). If a user token is read the carrier transitions to state 404, sets the status indicator 124 to correct operation (e.g. green), and waits for the load sensor 118 to sense the presence of user belongings i.e. weight. If user belongings are sensed the carrier transitions to state 406, sending an event signal for a carrier use start event; otherwise the carrier returns to state 402 after a timeout. The carrier then waits to sense removal of the user belongings, state 408, then sending an event signal for a carrier use stop event and returning to state 402. If the presence of user belongings is sensed before a user token has been read, state 410, the status indicator 124 is set to error (e.g. red). From state 410 the carrier can still reach the correct operation state 408 if a token is read; otherwise the carrier returns to state 402.

An example display of event signals (packets) from a carrier may include, for each event signal (packet), an identifier of a (type of) event, the carrier weight, the user token identifier (“NFC Tag”), and a time stamp.

An example display of data from interrogation of a user blockchain may include a user identifier (a “Passenger ID” including the user's name) presented with the user token identifier (“NFC ID”) and other travel details of the user. Underneath this may be presented data from a security check blockchain, here obtained via the underlying carrier blockchain. These data may comprise a scan start event (1) and a scan stop event (2) each linked to the user token identifier and having an associated carrier weight.

A security officer interface may be provided by a base station 130, optionally with an overlaid example of an event signal display. The display may show an animation of a carrier as it progresses through a baggage scanner, with optional additional information. Tabs at the bottom of the screen may be used to bring up information from one or more of the user blockchain, carrier blockchain, and security check blockchain.

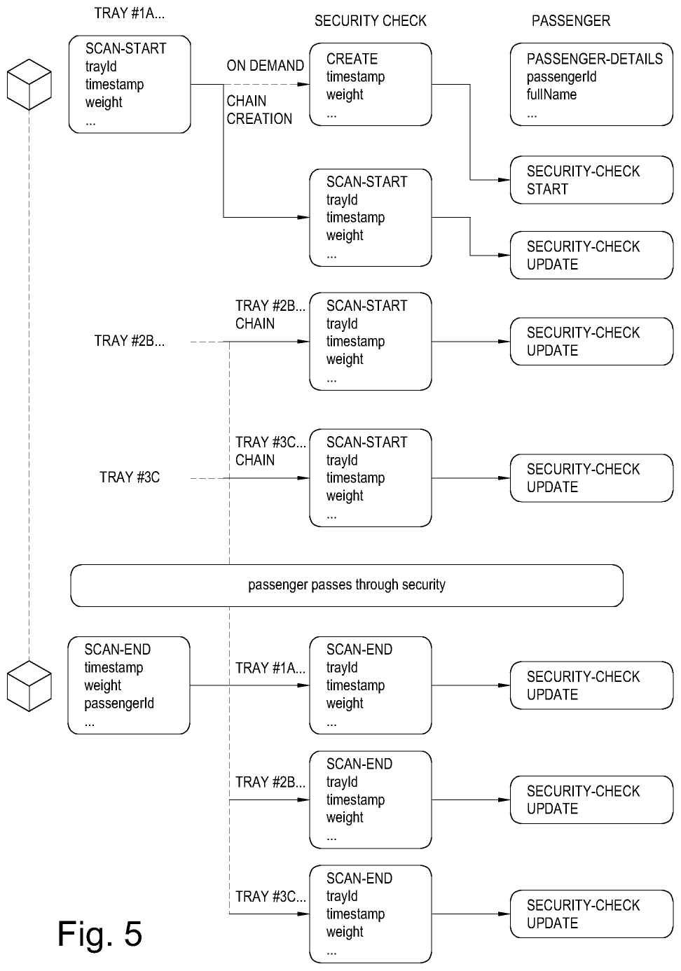

FIG. 5 shows, schematically, a blockchain data model which may be used by the security screening system 100, as previously described.

A security screening system 100 as described above may be used in a range of security monitoring settings, for example at an airport or rail station or other transport hub, or at the entrance to a building.

Features of the method and system which have been described or depicted herein in combination e.g. in an embodiment, may be implemented separately or in sub-combinations.

Features from different embodiments may be combined. Thus each feature disclosed or illustrated in the present specification may be incorporated in the invention, whether alone or in any appropriate combination with any other feature disclosed or illustrated herein. Method steps should not be taken as requiring a particular order e.g. that in which they are described or depicted, unless this is specifically stated. A system may be configured to perform a task by providing processor control code and/or dedicated or programmed hardware e.g. electronic circuitry to implement the task.

Aspects of the method and system have been described in terms of embodiments but these embodiments are illustrative only and the claims are not limited to those embodiments. Those skilled in the art will be able to make modifications and identify alternatives in view of the disclosure which are contemplated as falling within the scope of the claims.

1. A carrier to carry user belongings for a security screening system, the security screening system being configured to screen multiple carriers, the carrier comprising:
a token reader to wirelessly read a user token to determine a user token identifier;
a carrier identifier to distinguish the carrier from amongst the multiple carriers of the security screening system, wherein the carrier identifier is stored in the carrier; and
a carrier controller configured to:
read the user token of a user issued with the carrier to carry their belongings, to determine the user token identifier of the user;
store the user token identifier read from the user token;
read the stored carrier identifier; and
transmit the stored user token identifier in association with the stored carrier identifier.

2. The carrier of claim 1, wherein the carrier is a tray.

3. The carrier of claim 1, wherein the carrier controller is configured to detect one or more carrier events, and to transmit an event signal comprising the stored user token identifier in association with the stored carrier identifier in response to the detected one or more carrier events.

4. The carrier of claim 3, wherein the one or more carrier events include a carrier use start event and a carrier use stop event, and wherein the event signal identifies the detected carrier event.

5. The carrier of claim 4, further comprising a weight detection system, and wherein the carrier controller is configured to process a signal from the weight detection system to detect the one or more carrier events.

6. The carrier of claim 5, wherein the carrier comprises a lower part supported by a conveyor of the security screening system and an upper part to support the user belongings, and wherein the weight detection system comprises a load sensor between the lower part and the upper part.

7. The carrier of claim 5, further comprising a status indicator to indicate a readiness status of the carrier to the user; wherein carrier controller is configured to control the status indicator to indicate that the carrier is not ready in response to i) a signal from the weight detection system indicating detected weight in the carrier, and ii) absence of a signal from the token reader indicating that a user token has been read.

8. The carrier of claim 1, further comprising a re-chargeable power supply, a movement detector, and a power control system coupled to the re-chargeable power supply and to the movement detector and configured to wake the carrier controller from a reduced power consumption sleep mode on detection of movement.

9. The carrier of claim 1, wherein the carrier is stackable with other carriers and has electrodes at two points on a periphery of the carrier such that when the carrier is stacked the electrodes of adjacent carriers connect to form an electrically continuous connection through the stack.

10. The carrier of claim 9 wherein the electrodes comprise electrodes of two polarities, and wherein the carrier has two sets of the electrodes arranged with 2-fold rotational symmetry such that when the carrier is stacked electrodes of corresponding polarity of the adjacent carriers connect to form an electrically continuous connection through the stack for each of two rotational orientations of the carrier.

11. The carrier of claim 1, wherein the carrier is a tray comprising an inner shell and an outer shell, and wherein the carrier controller is mounted between side walls of the inner shell and the outer shell.

12. The carrier of claim 1, wherein the user token is a machine-readable user identity document or passport, and wherein the token reader is configured to read the user identity card or passport to determine the user token identifier.

13. The carrier of claim 1, wherein the user token identifier is anonymous.

14. The carrier of claim 1, further comprising a security screening system, wherein the screening system has a token interface which is configured to obtain a user identifier, to generate the user token identifier for the user, and to provide the user token with the user token identifier for the user.

15. The carrier of claim 3, further comprising a security screening system, wherein the carrier further comprises memory storing a carrier key, wherein the event signal is encrypted with the carrier key; and wherein the security screening system is configured to decrypt the event signal encrypted with the carrier key, and maintain a carrier blockchain for each carrier, wherein blocks of the carrier blockchain each comprise at least: data identifying the carrier event, a time of the carrier event, and the user token identifier.

16. The carrier of claim 15 wherein the security screening system is further configured to maintain a security check blockchain for each user, wherein blocks of the security check blockchain each comprise the carrier identifier of one or more carriers associated with the user, data identifying a carrier event for the identified carrier, and a time of the carrier event.

17. The carrier of claim 14, wherein the security screening system is further configured to maintain a user blockchain wherein at least one block of the user blockchain comprises at least the user token identifier and the user identifier.

18. The carrier of claim 1, further comprising a security screening system and a base station configured to communicate with the carrier and to provide an operator interface to allow an operator to access data from one or both of the stored user token identifier and the stored carrier identifier.

19. for the carrier of claim 15, wherein the security screening system comprises a server configured to:
receive the event signal is encrypted with the carrier key;
decrypt the event signal encrypted with the carrier key; and
add a block to a carrier blockchain for a carrier identified by the stored carrier identifier in the event signal, wherein the block comprises at least data identifying the carrier event, a time of the carrier event, and the user token identifier in the event signal.

20. (canceled)

21. A method performed by one or more computers, for monitoring screening of user belongings, comprising:
receiving from a carrier of user belongings an event signal identifying a carrier event and including a user token identifier associated with the user and a carrier identifier identifying the carrier; and
maintaining a first blockchain including blocks linking the carrier event, the user token identifier, and the carrier identifier.

22. (canceled)

23. (canceled)
